(19) United States
(12) Patent Application Publication
(10) Pub. No.: US 2005/0092782 A1
(43) Pub. Date: May 5, 2005

(54) Dispenser nozzle, dispenser incorporating the dispenser nozzle, method for dispensing a viscous substance

(76) Inventors: Hideki Takahashi, Kanagawa-ken (JP); Masaharu Ono, Kanagawa-ken (JP); Katsuhiko Mukai, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/971,003

(22) Filed: Oct. 25, 2004

(30) Foreign Application Priority Data
Oct. 23, 2003 (JP) 2003-362653

(51) Int. Cl. B67D 5/64

(52) U.S. Cl. 222/504

(57) ABSTRACT

A dispenser includes a supporting section configured to retain a circuit board at a predetermined height. A dispenser nozzle includes a nozzle tip having at least one hole, the nozzle tip configured to provide an adhesive substance to the circuit board. A driving mechanism is configured to drive the supporting section in a first direction and drive the dispenser nozzle in a second direction and a third direction. A circuit board fabricating method includes dispensing at least one droplet of an adhesive substance, having a shape extending toward a first direction, onto a predetermined point on a circuit board. A chip is placed onto the predetermined point to cover the droplet. The chip is soldered onto the predetermined point.

### CROSS REFERENCE TO RELATED APPLICATION

This application claims priority to Japanese patent application No. 2003-362653 filed on Oct. 23, 2003, the disclosure of which is incorporated by reference herein in its entirety.

### BACKGROUND OF THE INVENTION

1. Field of the Invention

The present invention relates to a dispenser nozzle, a dispenser including the dispenser nozzle, and a method for dispensing a viscous substance.

2. Discussion of the Background

In fabricating a printed circuit board, a chip or a socket is temporarily attached to the printed circuit board, and is directly soldered onto the printed circuit board.

FIGS. 1A to 1D show temporarily attachment of a chip 102 to a printed circuit board 101.

As shown in FIGS. 1A and 1B, a single droplet 104 of substantially circular shape, which contains adhesive substance, is dispensed by a dispenser (not shown) onto a predetermined point between pads 103a and 103b of the printed circuit board 101.

Thereafter, as shown in FIGS. 1C and 1D, the chip 102 is placed on the predetermined point so as to cover the droplet 104. In this case, the chip 102 is placed such that its respective sides, having electrode sections 105a and 105b, cover the corresponding sides of the pads 103a and 103b. The droplet 104 is then heated by a hardening furnace (not shown) to securely keep the chip 102 to the predetermined point.

FIGS. 2A to 2D show another embodiment of a temporarily attachment of the chip 102 to the printed circuit board 101. In this case, a double droplet 104 is dispensed by a dispenser (not shown), instead of the single droplet 104 shown in any one of FIGS. 1A to 1D.

In either of the above background operations, the dispenser should dispense a sufficient amount of adhesive substance onto a predetermined point with high precision. However, with the recent trend in chip miniaturization, it becomes increasingly difficult to achieve such an amount.

### SUMMARY OF THE INVENTION

The present invention can provide a dispenser including a supporting section configured to retain a circuit board at a predetermined height. A dispenser nozzle includes a nozzle tip having at least one hole, the nozzle tip configured to provide an adhesive substance to the circuit board. A driving mechanism is configured to drive the supporting section in a first direction and drive the dispenser nozzle in a second direction and a third direction.

The present invention can further provide a circuit board fabricating method including dispensing at least one droplet of an adhesive substance, having a shape extending toward a first direction, onto a predetermined point on a circuit board. A chip is placed onto the predetermined point to cover the droplet. The chip is soldered onto the predetermined point.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1C are plan views showing temporary attachment of a chip to a printed circuit board before soldering.

FIGS. 1B and 1D are front views corresponding to FIGS. 1A and 1C, respectively.

FIGS. 2A and 2C are plan views showing another embodiment of a temporary attachment of a chip to a printed circuit board before soldering.

FIGS. 2B and 2D are front views corresponding to FIGS. 2A and 2C, respectively.

FIG. 3 is a perspective view showing a dispenser according to an embodiment of the present invention.

FIG. 4 is a front view showing soldering of a printed circuit board of FIG. 3.

FIG. 5 is a perspective view showing a dispenser nozzle according to an embodiment of the present invention.

FIG. 6 is a front view showing an interior of the dispenser nozzle of FIG. 5.

FIG. 7 is a perspective view showing dispensing performed by the dispenser nozzle of FIG. 5.

FIG. 8 is a partially enlarged view of the dispenser nozzle of FIG. 7.

FIG. 9 is a perspective view showing a dispenser nozzle according to another embodiment of the present invention.

FIG. 10 is a perspective view showing dispensing performed by the dispenser nozzle of FIG. 9.

FIG. 11 is a partially enlarged view of the dispenser nozzle of FIG. 10.

FIG. 12 is a schematic diagram showing a driving mechanism according to an embodiment of the present invention.

FIG. 13 shows items of information stored in the driving mechanism of FIG. 12.

FIG. 14 is a flowchart showing dispensing performed by the driving mechanism of FIG. 12.

FIG. 15 is a schematic diagram showing a driving mechanism according to another embodiment of the present invention.

FIGS. 16A and 16B are front views showing rotation of the nozzle tip.

FIGS. 17A and 17B are flowcharts showing dispensing performed by the driving mechanism of FIG. 15.

FIG. 18 is a schematic diagram showing a driving mechanism according to another embodiment of the present invention.

FIGS. 19A and 19B are flowcharts showing dispensing performed by the driving mechanism of FIG. 18.

FIGS. 20A and 20B are bottom views showing installation of a dispenser nozzle to the dispenser of FIG. 3.

FIGS. 21A and 21B are front views corresponding to FIGS. 20A and 20B, respectively.

FIGS. 22A and 22B are front views showing installation of a dispenser nozzle to the dispenser of FIG. 3.

### DETAILED DESCRIPTION

In describing preferred embodiments shown in the drawings, predetermined terminology is employed for clarity. However, it is to be understood that the description is not intended to be limited to the predetermined terminology, and it is to be understood that each predetermined element includes all equivalents that operate in a similar manner.

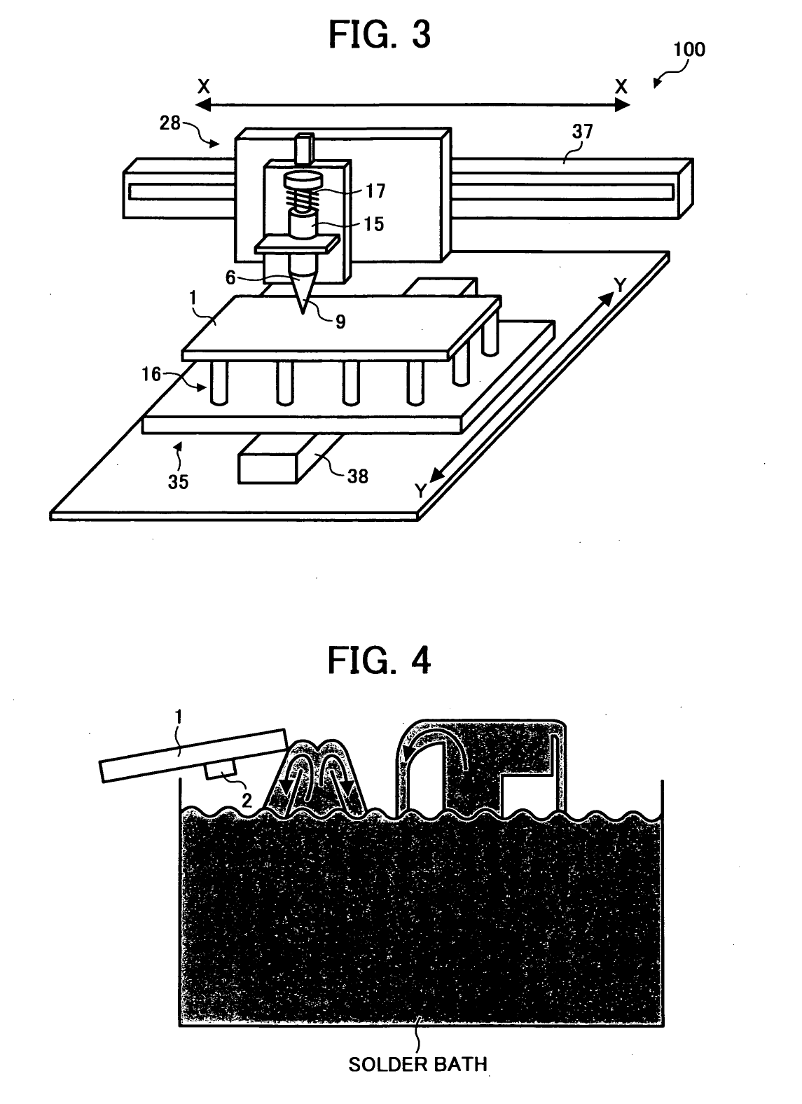

Referring to the drawings, wherein like reference numerals designate identical, corresponding, or similar parts throughout the several views, FIG. 3 shows a dispenser 100 according to an embodiment of the present invention.

The dispenser 100 is configured to dispense a relatively small amount of viscous substance onto a predetermined point on a planar surface. For example, as shown in FIG. 3, the dispenser 100 is configured to dispense a relatively small amount of adhesive substance onto a predetermined point on a printed circuit board 1. In this case, any kind of adhesive substance may be used, as long as the adhesive can sufficiently bind various chips onto the printed circuit board 1.

Such binding is preferably performed before soldering, as shown in FIG. 4. In this way, a chip 2, for example, is prevented from falling into a solder bath.

The dispenser 100 includes a head section 28, a plurality of supporting pins 16, a table 35, a head guide 37, and a table guide 38.

The head section 28 includes a dispenser nozzle 6 having a nozzle tip 9 at its end, a dispenser head 15, and a buffer 17. The dispenser nozzle 6 preferably has a conical shape as shown in FIG. 3, and is previously attached to the dispenser head 15. The dispenser nozzle 6 previously stores an adhesive substance in its interior, and dispenses a predetermined amount of the adhesive substance through the nozzle tip 9. The dispenser head 15 moves vertically with respect to the surface of the printed circuit board 1 according to an instruction received from a driving mechanism (not shown). By this movement, the dispenser head 15 adjusts a distance between the nozzle tip 9 and the board surface. The buffer 17 may be optionally provided on the upper side of the dispenser head 15 to reduce damage on the board surface, which may be caused by the nozzle tip 9. Specifically, the buffer 17 reduces pressure that may be applied to the board surface, when the nozzle tip 9 is brought in close contact with the board surface.

The printed circuit board 1 is placed above the table 35 at a predetermined height determined by the plurality of supporting pins 16. The lengths of the supporting pins 16, i.e., the height of the printed circuit board 1 from the table 35, may differ depending on the machine configuration. Further, it may be adjusted to provide a predetermined distance between the nozzle tip 9 and the board surface.

To temporarily attach the chip 2 onto a predetermined point on the printed circuit board 1, the nozzle tip 9 and the predetermined point of the printed circuit board 1 are precisely positioned to oppose each other. This may be achieved by the driving mechanism configured to control the movements of the head section 28 and the table 35, respectively. Specifically, the head section 28 slides along the head guide 37 in the direction indicated as X, by a head motor (not shown) controlled by the driving mechanism. The table 35 slides along the table guide 38 in the direction indicated as Y, by a table motor (not shown) controlled by the driving mechanism.

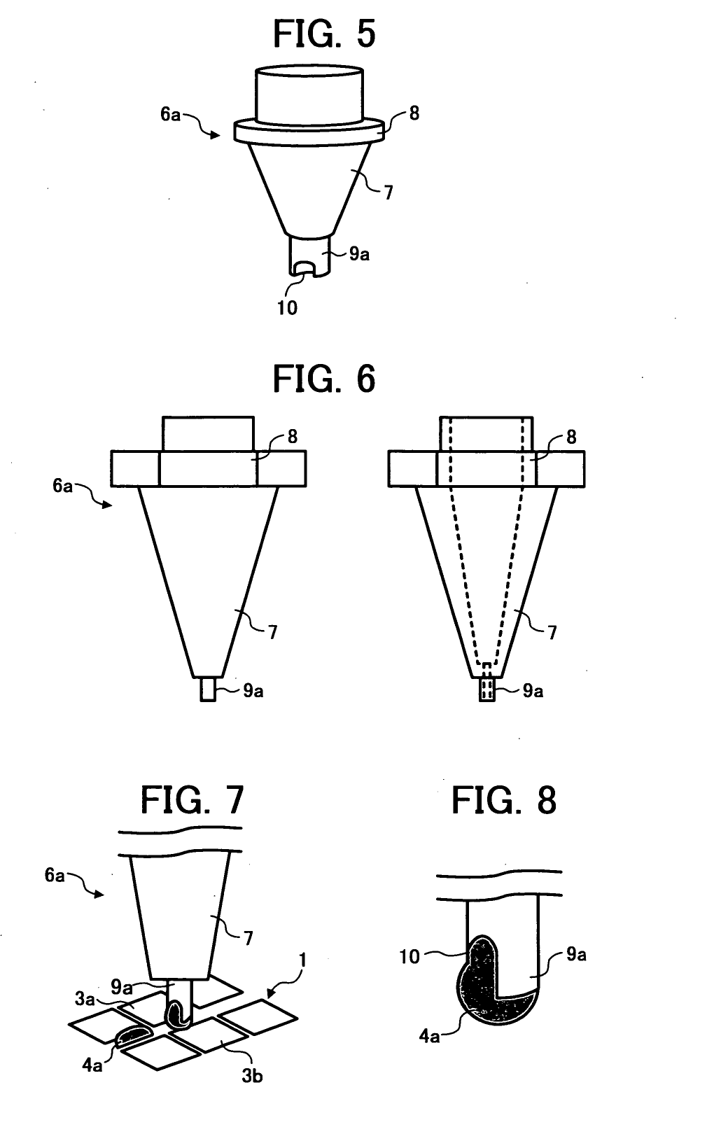

FIG. 5 shows an embodiment of the dispenser nozzle. The dispenser nozzle 6a includes a nozzle body 7, a connector 8, and a nozzle tip 9a having a groove 10.

The nozzle body 7, which has a nearly conical shape, is connected to the dispenser head 15 through the connector 8 having a substantially cylindrical shape. The nozzle body 7 has a hollow interior, and contains therein an adhesive substance. As shown in FIG. 6, the hollow interior preferably has a tapered shape, which is narrower toward the nozzle tip 9a. With this configuration, the dispenser nozzle 6a can dispense a sufficient amount of adhesive substance more smoothly.

The nozzle tip 9a preferably has a cylindrical shape with a circular cross section, as shown in FIG. 5. The nozzle tip 9a has one end attached to the end of the nozzle body 7, and has the other end having an opening toward the board surface. The other end of the nozzle tip 9a is provided with the groove 10 having a concave shape. Alternatively, the nozzle tip 9a may be formed into a cylindrical shape with an oval cross section, or it may be formed into a polygonal column shape with a polygonal cross section.

FIG. 7 shows dispensing of a relatively small amount of adhesive substance performed by the dispenser nozzle 6a.

First, the center of the nozzle tip 9a is positioned above a predetermined point between the pads 3a and 3b, by the driving mechanism. The dispenser nozzle 6a is then lowered until the nozzle tip 9a is disposed a predetermined distance from the predetermined point on the printed circuit board 1.

The dispenser nozzle 6a disposes a droplet 4a containing a sufficient amount of adhesive substance, from the nozzle body 7 through the nozzle tip 9, onto the predetermined point of the printed circuit board 1.

As shown in FIG. 7, the droplet 4a has substantially an oval shape, and can sufficiently bind the chip 2 onto the printed circuit board 1, without contaminating the pad 3a or 3b. Formation of the oval shape of droplet 4a is achieved through the groove 10 of the tip nozzle 9a, as shown in FIG. 8. Specifically, the central section of the nozzle tip 9a, i.e., the portion other than the groove 10, acts as a stopper to limit the amount of adhesive substance dispensed from the central section.

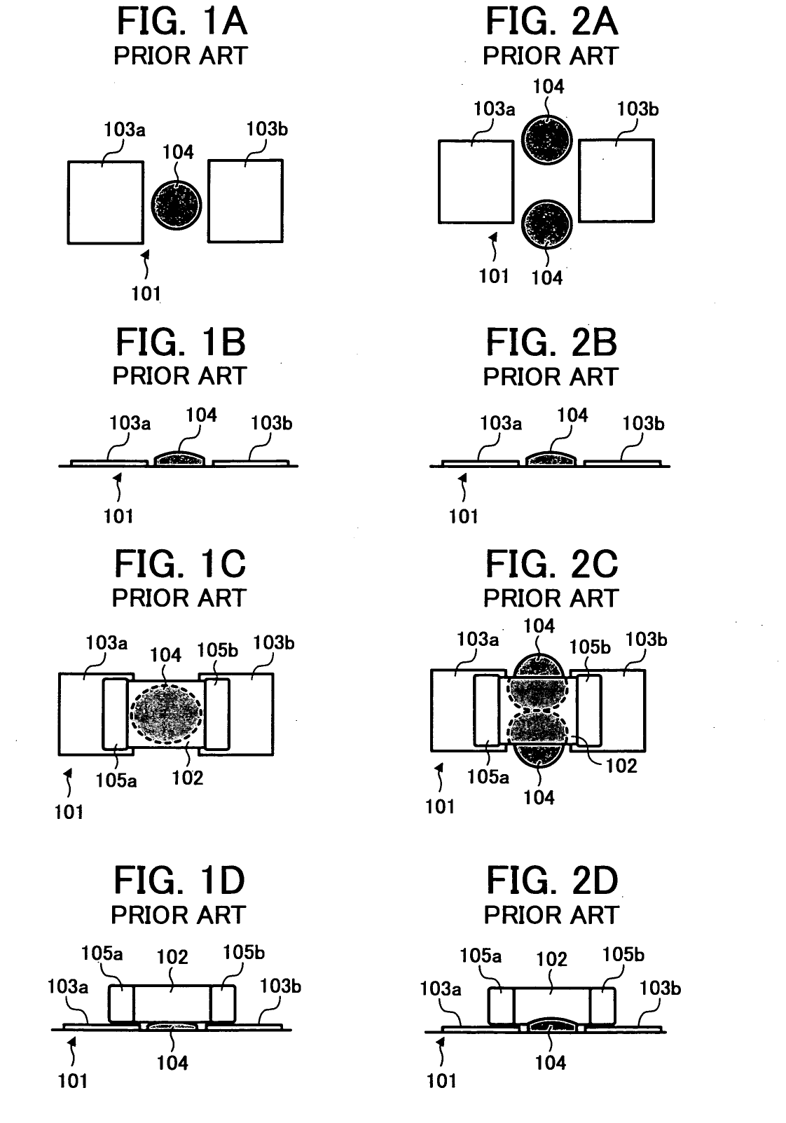

As discussed above, the shape of the droplet 4a may differ depending on the shape of the nozzle tip 9a. However, the droplet 4a extends toward one direction (either X or Y direction in FIG. 3), when compared with the droplet 104 shown in any of FIGS. 1A to 1D.

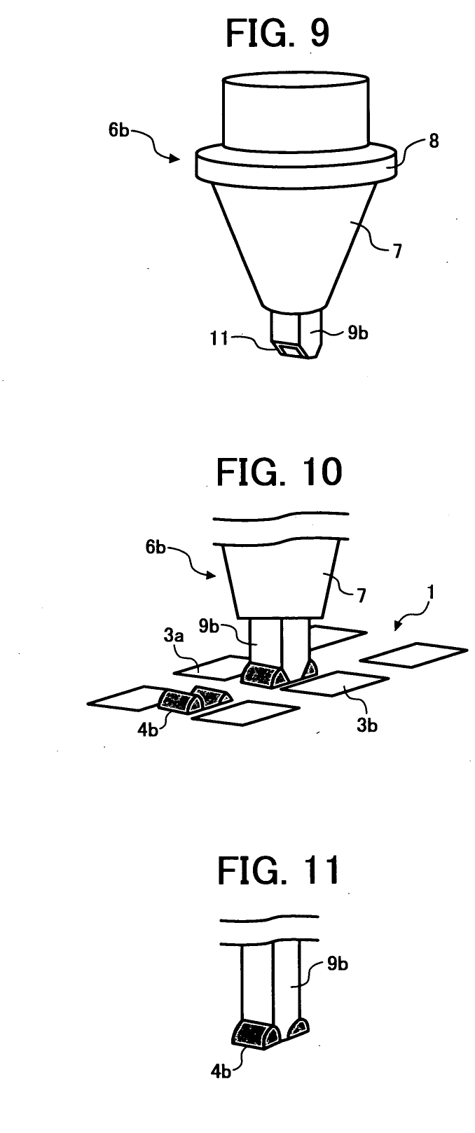

FIG. 9 shows another embodiment of the dispenser nozzle. The dispenser nozzle 6b is similar to the dispenser nozzle 6a of FIG. 5, except with respect to the nozzle tip 9b. Specifically, the nozzle tip 9b has a cut section 11, which is previously formed by cutting two sides of the nozzle tip 9b at a slant. Although the angles of the slants for the respective sides are similar in FIG. 9, the angles may be different from each other. Further, although the nozzle tip 9b has a rectangular column shape with a rectangular cross section in FIG. 9, the nozzle tip may be formed into a cylindrical shape or a polygonal column shape, as described above with reference to FIG. 5.

FIG. 10 shows dispensing a relatively small amount of adhesive substance performed by the dispenser nozzle 6b. The dispenser nozzle 6b forms a droplet 4b of nearly mountain shape having peaks or a valley between the peaks. With this shape, the droplet 4b can sufficiently bind the chip 2 onto the printed circuit board 1, without contaminating the pad 3a or 3b. Formation of the droplet 4b is achieved through the cut section 11 of the tip nozzle 9b, as shown in FIG. 11. Specifically, the central section of the nozzle tip 9b, i.e., the portion other than the cut section 11, acts as a stopper.

As discussed above, the shape of the droplet 4b may differ depending on the shape of the nozzle tip 9b. However, the droplet 4b extends toward one direction (either X or Y direction in FIG. 3), when compared with the droplet 104 shown in any of FIGS. 2A to 2D. The nozzle tip 9b may provide a single droplet or a double droplet, depending on its shape.

The nozzle tip 9 (including the nozzles 9a and 9b) can be formed from various materials, including known materials. In a preferred embodiment, the material includes stainless steel, which provides high resistance to corrosion.

A surface of the nozzle tip 9 can be quenched to increase its resistance to corrosion. In quenching, the heated steel is cooled very rapidly by water or oil such that the strong state of the steel crystal structure is maintained even after cooling.

In another example, coating or plating may be applied to the surface of the nozzle tip 9 to reduce friction and wear. For example, chrome plating may be applied, which uses the electrolytic deposition of chromium.

In yet another example, case hardening may be applied to the surface of the nozzle tip 9. For example, nitriding may be applied, which depends on the absorption of nitrogen into the steel, to increase surface hardness, resistance to corrosion, and/or fatigue strength.

In addition to the above exemplary treatments, other known treatments may be applied to the nozzle tip 9 to increase corrosion resistance.

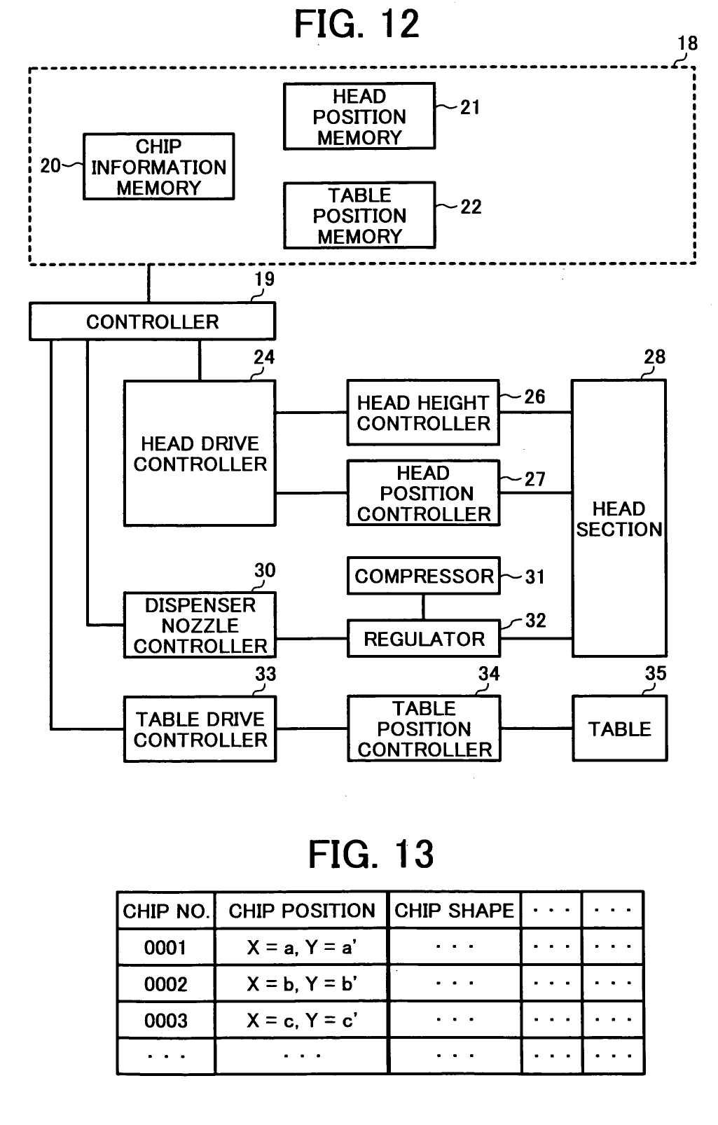

FIG. 12 shows an embodiment of the driving mechanism. The driving mechanism controls the respective movements of the head section 28 and the table 35, as well as the dispensing operation performed by the dispenser nozzle 6.

The driving mechanism of FIG. 12 includes a storage device 18, a controller 19, a head drive controller 24, a head height controller 26, a head position controller 27, a dispenser nozzle controller 30, a compressor 31, a regulator 32, a table drive controller 33, and a table position controller 34.

The storage device 18 stores various information including information regarding various chips to be adhered to the printed circuit board 1 (referred to as the “chip information”), and information regarding the respective positions of the head section 28 and the table 35 (referred to as the “head position information” and the “table position information”, respectively), for example.

As shown in FIG. 12, the storage device 18 includes a chip information memory 20, a head position memory 21, and a table position memory 22, for example. The chip information memory 20 stores the chip information. As shown in FIG. 13, the chip information includes, for example, chip number information, chip position information, and chip shape information. The chip number information is used to identify a predetermined chip from the various chips to be adhered to the printed circuit board 1. The chip position information indicates the position on the printed circuit board 1 where the predetermined chip is to be implemented, and is expressed in the XY coordinate system, with the X referring to the direction X shown in FIG. 3 and the Y referring to the direction Y shown in FIG. 3. The chip shape information indicates the shape of the predetermined chip. These items of information are stored in a corresponding manner as shown in FIG. 13. The head position memory 21 includes the head position information. The table position memory 22 includes the table position information.

The controller 19 controls operation of the driving mechanism. Specifically, the controller 19 stores at least one controlling software program used for controlling the operation of the driving mechanism, such a known NC (numerical control) program.

The head drive controller 24 drives the head section 28 in the vertical and X directions, by using the head height controller 26 and the head position controller 27. The head height controller 26 controls the height of the head section 28 with respect to the surface of the printed circuit board 1, as a result of an instruction provided by the controller 19. The head position controller 27 controls the position of the head section 28 in the X direction, which is horizontal with respect to the board surface, as a result of an instruction provided by the controller 19.

The dispenser nozzle controller 30 causes the dispenser nozzle 6 to dispense a predetermined amount of adhesive substance. Specifically, the compressor 31 compresses air to provide a predetermined amount of air pressure, which is necessary to push out the predetermined amount of adhesive substance. The amount of air pressure is controlled by the regulator 32, according to an instruction received from the controller 19.

The table drive controller 33 drives the table 38 in the Y direction, by using the table position controller 34. The table position controller 34 controls the position of the table 38 in the Y direction, as a result of an instruction provided by the controller 19.

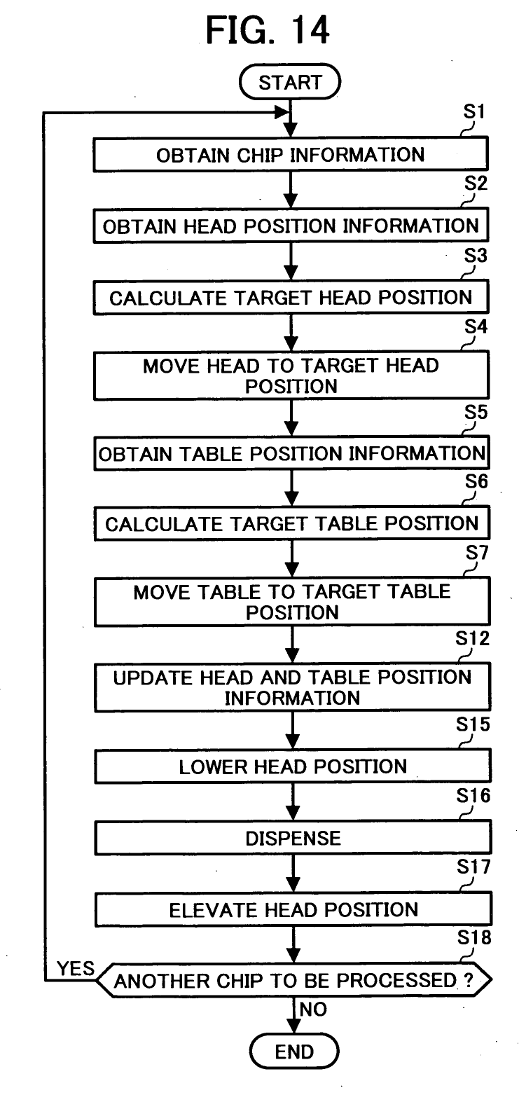

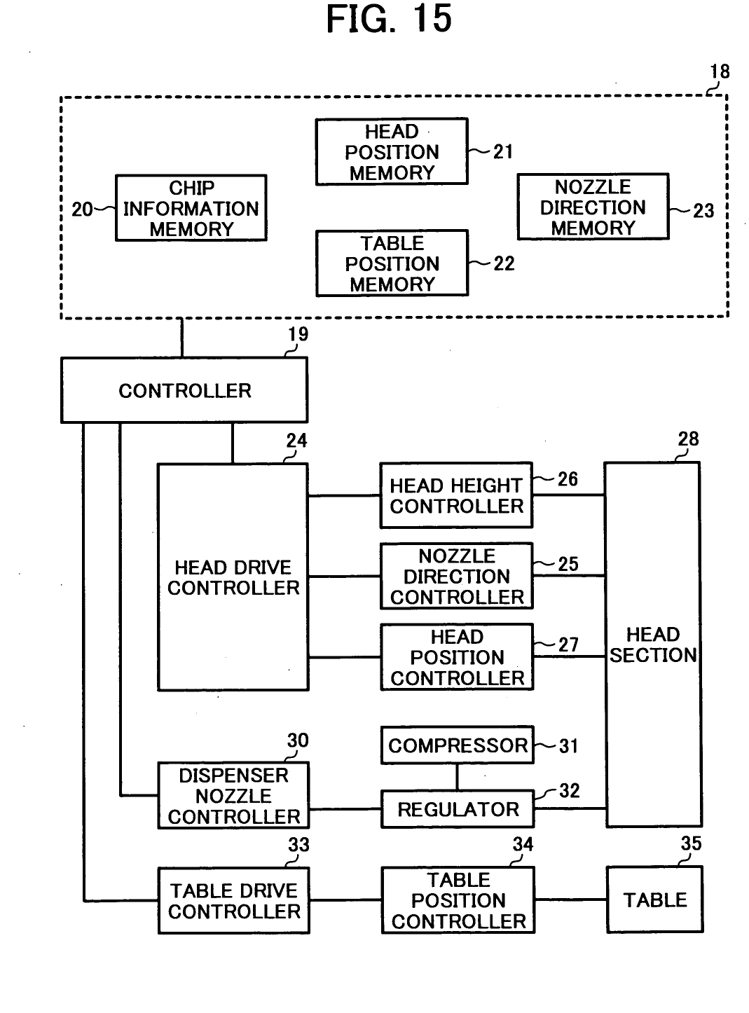

FIG. 14 shows dispensing a relatively small amount of adhesive substance performed by the dispenser 100 including the driving mechanism of FIG. 12. Specifically, the steps shown in FIG. 14 are performed when the controller 19 loads the controlling program. This exemplary case assumes that the chip 2 is temporarily attached to the printed circuit board 1.

In step S1, the controller 19 obtains chip information regarding a chip 2 from the chip information memory 20. In this case, the chip information includes at least chip position information indicating the position of the printed circuit board 2 on which the chip 2 is to be adhered (referred to as “target chip position”).

In step S2, the controller 19 obtains current head position information indicating the current position of the head section 28, from the head position memory 21.

In step S3, the controller 19 generates target head position information indicating the target head position of the head section 28, using the information obtained in the previous steps S2 and S3. Specifically, the controller 19 calculates the target head position, which is a distance between the current head position and the target chip position.

In step S4, based on the target head position information obtained in step S3, the controller 19 moves the head section 28 in the X direction, specifically, to the target head position.

In step S5, the controller 19 obtains current table position information indicating the current position of the table 35.

In step S6, the controller 19 generates target table position information indicating the target position of the table 35, using the information obtained in steps S1 and S5. Specifically, the controller 19 calculates the target table position, which is a distance between the current table position and the target chip position.

In step S7, based on the target table position information obtained in step S6, the controller 19 moves the table 35 in the Y direction, specifically, to the target table position.

Through the steps S1 to S7, the head section 28 is positioned above the target chip position on the printed circuit board 1.

In step S12, the controller 19 updates the head position information and the table position information, and stores the updated information in the storage device 18.

In step S15, the controller 19 lowers the head section 28 to provide a predetermined distance between the nozzle tip 9 and the target chip position.

In step S16, the controller 19 dispenses a relatively small amount of adhesive substance onto the target chip position.

In step S17, the controller 19 elevates the head position 28 back to the original position.

In step S18, the controller 19 determines whether another chip is to be adhered to the printed circuit board 1. If another chip is to be adhered to the printed circuit board 1, the process returns to step S1 to repeat the steps S1 to S18. If another chip is not to be adhered to the printed circuit board 1, the process ends.

FIG. 15 shows another embodiment of the driving mechanism. The driving mechanism of FIG. 15 is similar to the driving mechanism of FIG. 12, except with respect to the addition of a nozzle direction memory 23 and a nozzle direction controller 25.

The nozzle direction memory 23 of the storage device 18 stores nozzle direction information indicating the direction of the nozzle tip 9. Thus, the direction of the nozzle tip 9 rotates according to the target chip position.

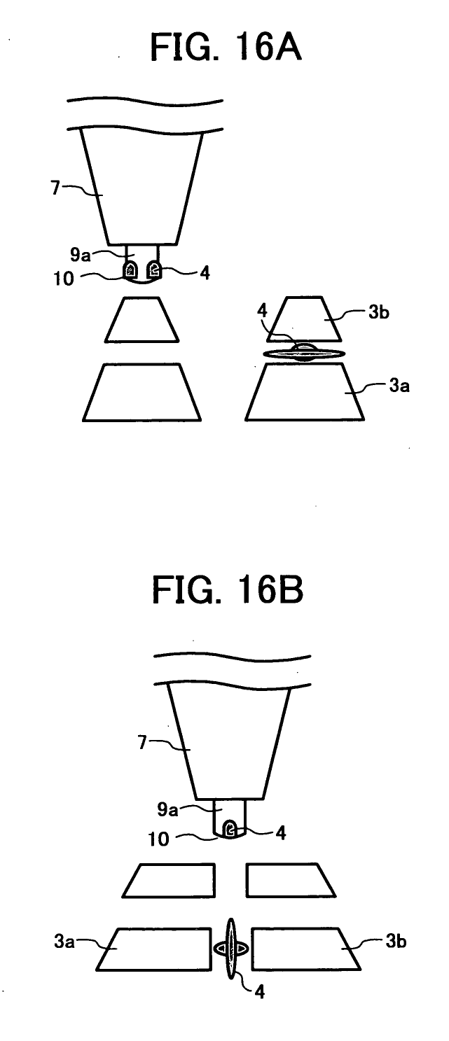

FIGS. 16A and 16B show rotation of the nozzle tip 9a according to the target chip position. For example, as shown in FIG. 16A, if the target chip position extends in the X direction, the line passing through the groove 10 should be parallel to the X direction. As shown in FIG. 16B, if the target chip position extends in the Y direction, the line of the groove 10 should be parallel to the Y direction. In this way, the droplet 4a of substantially oval shape is kept away from the pad 3a or 3b, as described above with reference to FIG. 7. FIGS. 16A and 16B show the dispenser nozzle 6a, however, the nozzle tip 9b of the dispenser nozzle 6b may be rotated in a similar manner.

In this case, information indicating whether the target chip position extends in the X direction or Y direction is previously stored in the chip information memory 20, as chip direction information. Particularly, in this exemplary case, a state A is assigned when the target chip position extends in the X direction, and a state B is assigned when the target chip position extends in the Y direction. According to this chip direction information, the controller 19 determines whether the direction of the nozzle tip 9 should be changed.

As shown in FIG. 15, the nozzle direction controller 25 changes the direction of the nozzle tip 9, according to an instruction received from the controller 19.

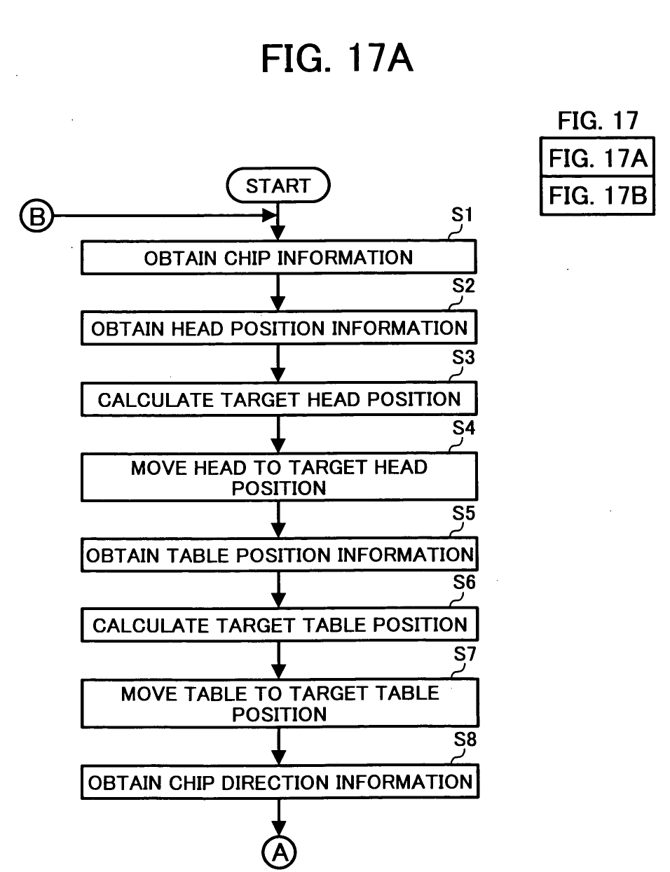

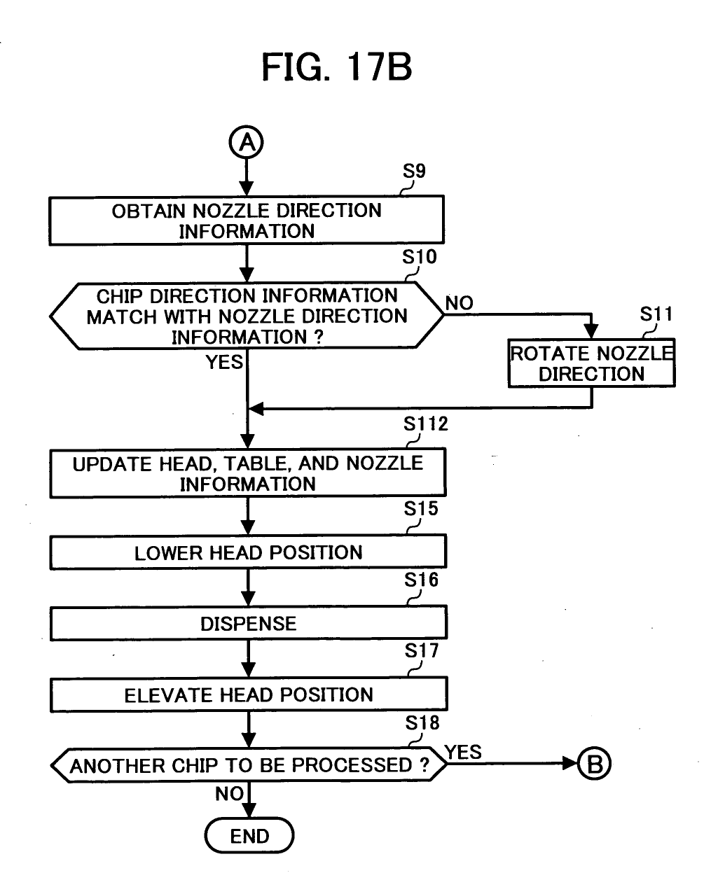

FIGS. 17A and 17B show dispensing of a relatively small amount of adhesive substance performed by the dispenser 100 including the driving mechanism of FIG. 15. The steps shown in FIGS. 17A and 17B are similar to the steps shown in FIGS. 14A and 14B, except with respect to the addition of steps S8 to S11 and the replacement of step S12 with step S112.

In step S8, the controller 19 obtains chip direction information of the target chip 2 indicating the direction of the target chip position, from the chip information memory 20.

In step S9, the controller 19 obtains nozzle direction information indicating the current direction of the nozzle tip 9, from the nozzle direction memory 23.

In step S10, based on the information obtained in the previous steps S8 and S9, the controller 19 determines whether the current nozzle direction corresponds to the direction of the target chip position. If yes, the process moves to step S112. If no, the process moves to step S11.

In step S11, the controller 19 rotates the nozzle tip 9 such that the line passing through the groove 10 or the cut section 11 becomes parallel to the direction of the target chip position.

In step S112, the controller 19 updates the head position information, the table position information, and the nozzle direction information, and stores the updated information in the storage device 18.

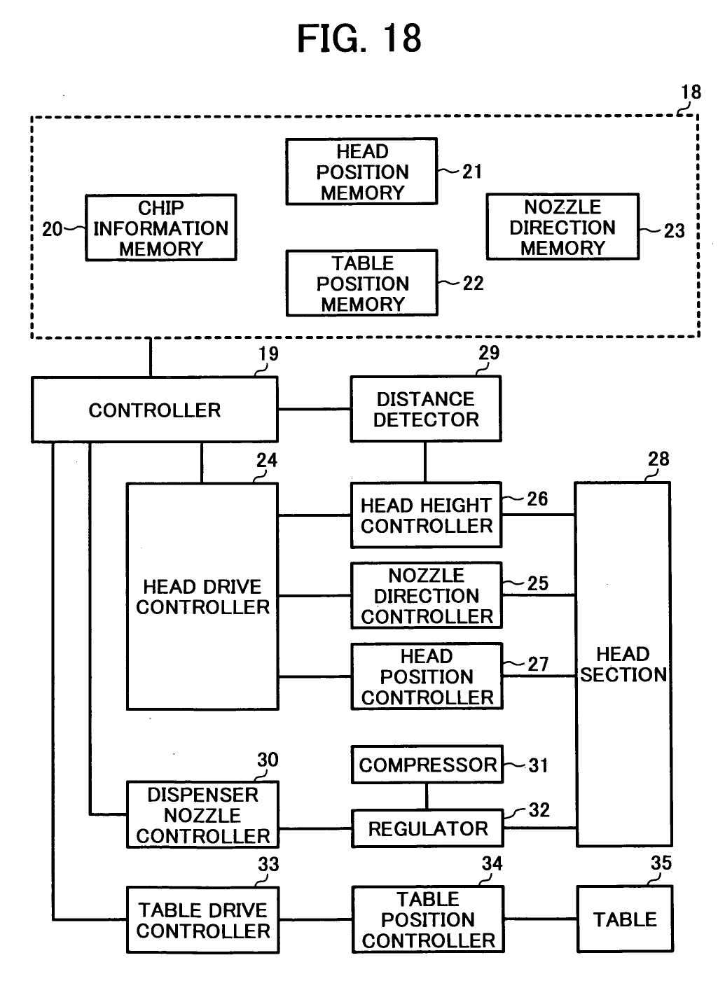

FIG. 18 shows another embodiment of the driving mechanism. The diving mechanism of FIG. 18 is similar to the driving mechanism of FIG. 15, except with respect to the addition of a distance detector 29.

The distance detector 29 detects a distance between the nozzle tip 9 and the upper surface of the printed circuit board 1. The distance detector 29 can include known sensors or limiting switches.

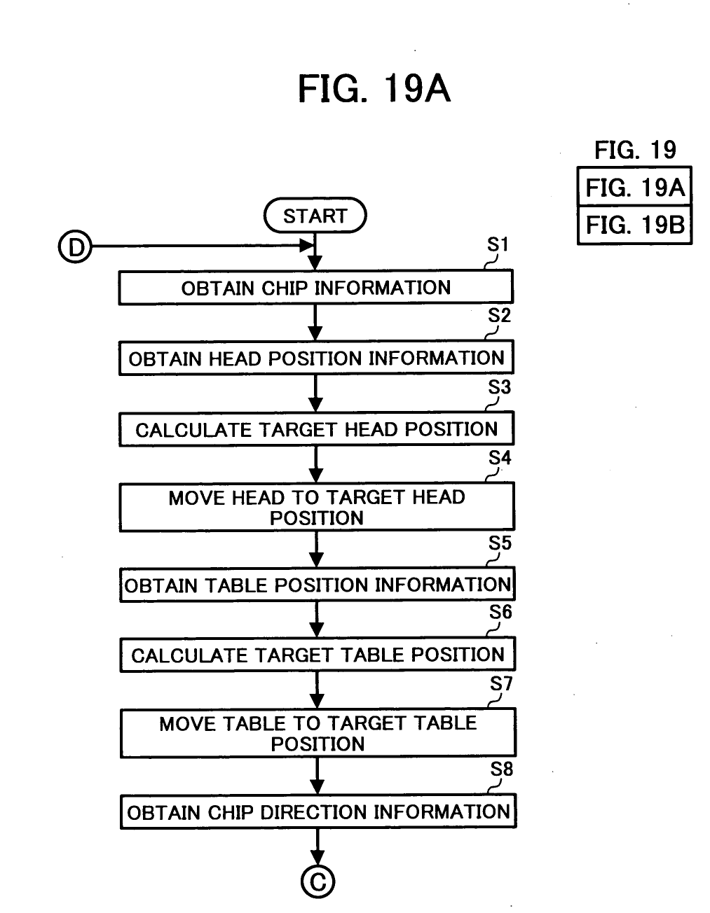

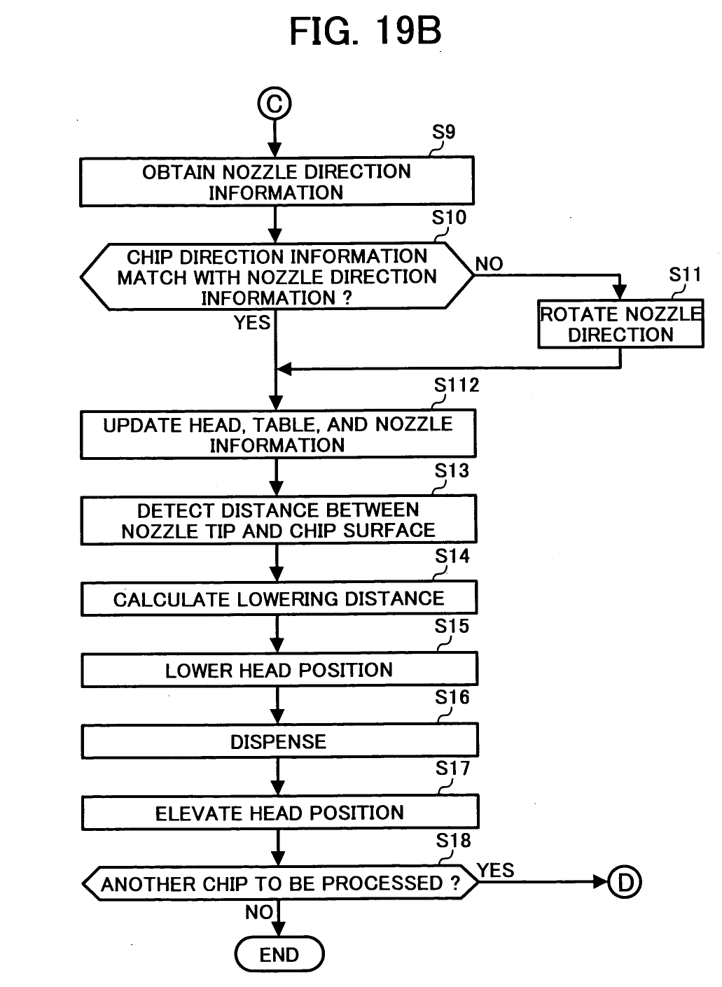

FIGS. 19A and 19B show dispensing of a relatively small amount of adhesive substance performed by the dispenser 100 including the driving mechanism of FIG. 18. The steps shown in FIGS. 19A and 19B are similar to the steps shown in FIGS. 17A and 17B, except with respect to the addition of steps S13 and S14.

In step S13, the controller 19 detects a distance between the nozzle tip 9 and the surface of the target chip position on the printed circuit board 1, using the distance detector 29.

In step S14, the controller 19 calculates a target lowering distance indicating the distance that the head section 28 is to be lowered. Specifically, the controller 19 calculates the difference between the detected distance (obtained in step S13) and a predetermined distance, which allows sufficient binding while preventing the nozzle tip 9 from directly contacting the board surface. The predetermined distance is previously stored in the storage device 18, and it may vary according to the machine configuration.

Thus, in step S15, the controller 19 lowers the head position 28 according to the target lowering distance obtained in step S14.

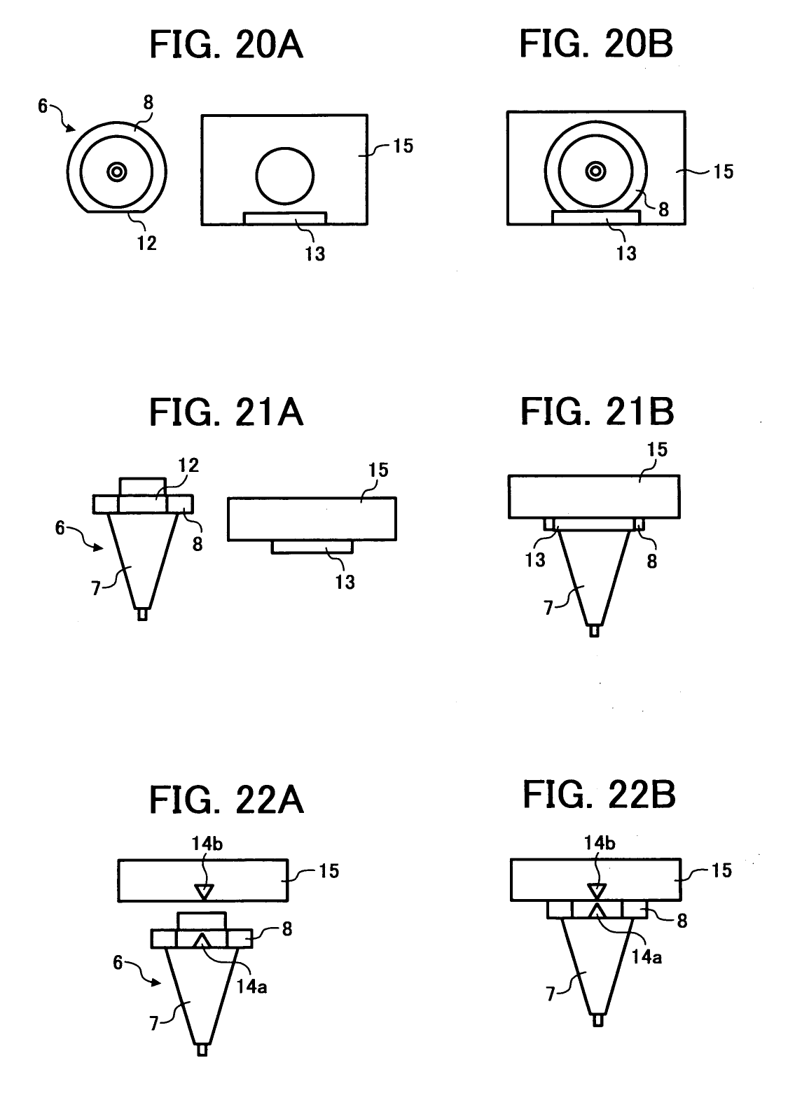

FIGS. 20A to 22B show installation of the nozzle tip 9 to the dispenser nozzle 6.

As described above, the nozzle tip 9 can be aligned with high precision corresponding to the direction of the target chip position. Thus, the direction of the nozzle tip 9 can be controlled during its installation, by using any of the methods shown in FIGS. 20A to 22B or other known methods.

As shown in FIGS. 20A and 21A, the connector 8 includes a concave section 12. The dispenser head 15 includes a convex section 13, which corresponds to the concave section 12. When installing the dispenser nozzle 6 onto the dispenser head 15 (FIGS. 20B and 21B), the dispenser nozzle 6 is disposed such that the concave section 12 and the convex section 13 oppose each other. Subsequently, the convex section 13 is brought into direct contact with the concave section 12.

As shown in FIGS. 22A and 22B, the connector 8 includes a mark 14a, and the dispenser head 15 includes a mark 14b. When installing the dispenser nozzle 6 onto the dispenser head 15 (FIG. 22B), the dispenser nozzle 6 is placed such that the mark 14a and the mark 14b oppose each other.

Numerous additional modifications and variations are possible in light of the above teachings. It is therefore to be understood that within the scope of the appended claims, the invention may be practiced otherwise than as specifically described herein.

For example, elements and/or features of different illustrative embodiments may be combined with each other and/or substituted for each other within the scope of this disclosure and appended claims.

Further, the present invention may be applied to achieve objectives other than temporarily binding of a chip onto a printed circuit board. In such a case, other type of viscous substance may be used.

1. A dispenser nozzle, comprising:
a nozzle tip having a groove at an end thereof, the groove configured to deliver a viscous substance retained in the dispenser nozzle.

2. The dispenser nozzle of claim 1, wherein the nozzle tip is configured to deliver an amount of the viscous substance to bond a chip to a circuit board.

3. The dispenser nozzle of claim 1, wherein the nozzle tip comprises a material having high corrosion resistance.

4. The dispenser nozzle of claim 1, further comprising:
a nozzle body having a hollow interior and configured to store the viscous substance in the interior.

5. The dispenser nozzle of claim 4, wherein the interior comprises a tapered shape.

6. The dispenser nozzle of claim 1, further comprising:
a connector configured to connect the dispenser nozzle to an outside device.

7. The dispenser nozzle of claim 6, wherein the connector comprises a first section at a predetermined position configured to correspond to a second section of the outside device at a position corresponding to the predetermined position.

8. The dispenser nozzle of claim 7, wherein the first section is configured to connect with the second section when the dispenser nozzle is connected to the outside device.

9. The dispenser nozzle of claim 8, wherein the first section includes a concave section configured to connect with a convex section of the second section.

10. The dispenser nozzle of claim 6, wherein the first section includes a first mark configured to correspond to a second mark of the second section.

11. A dispenser nozzle, comprising:
a nozzle tip having a cut section at an end, the cut section configured to provide a viscous substance retained in the dispenser nozzle.

12. The dispenser nozzle of claim 11, wherein the cut section comprises a slanted surface.

13. The dispenser nozzle of claim 11, wherein the nozzle tip is configured to deliver an amount of the viscous substance to bond a chip to a circuit board.

14. The dispenser nozzle of claim 11, wherein the nozzle tip comprises a material having high corrosion resistance.

15. The dispenser nozzle of claim 1, further comprising:
a nozzle body having a hollow interior and configured to store the viscous substance in the interior.

16. The dispenser nozzle of claim 15, wherein the interior comprises a tapered shape.

17. The dispenser nozzle of claim 11, further comprising:
a connector configured to connect the dispenser nozzle to an outside device.

18. The dispenser nozzle of claim 17, wherein the connector comprises a first section at a predetermined position configured to correspond to a second section of the outside device at a position corresponding to the predetermined position.

19. The dispenser nozzle of claim 18, wherein the first section is configured to connect with the second section when the dispenser nozzle is connected to the outside device.

20. The dispenser nozzle of claim 17, wherein the first section includes a concave section configured to connect with a convex section of the second section.

21. The dispenser nozzle of claim 20, wherein the first section includes a first mark configured to correspond to a second mark of the second section.

22. A dispenser, comprising:
a supporting section configured to retain a circuit board at a predetermined height;
a dispenser nozzle comprising a nozzle tip having at least one hole, the nozzle tip configured to provide an adhesive substance to the circuit board; and
a driving mechanism configured to drive the supporting section in a first direction and drive the dispenser nozzle in a second direction and a third direction.

23. The dispenser of claim 22, wherein the hole comprises a groove on the nozzle tip.

24. The dispenser of claim 22, wherein the hole comprises a slanted surface on the nozzle tip.

25. The dispenser of claim 22, further comprising:
a buffer configured to reduce a pressure applied by the nozzle tip to a surface of the circuit board.

26. The dispenser of claim 22, wherein the driving mechanism comprises:
a nozzle position controller configured to control a position of the dispenser nozzle in the second direction; and
a height controller configured to control the position of the dispenser nozzle in the third direction.

27. The dispenser of claim 22, wherein the driving mechanism comprises:
a supporting section position controller configured to control a position of the supporting section in the first direction.

28. The dispenser of claim 22, wherein the driving mechanism comprises a nozzle direction controller configured to control a direction of the nozzle tip in the first and second directions.

29. The dispenser of claim 22, wherein the driving mechanism comprises a distance detector configured to detect a distance between the nozzle tip and a surface of the circuit board.

30. The dispenser of claim 29, wherein the driving mechanism is configured to control the position of the dispenser nozzle in the third direction according to the detected distance of the distance detector.

31. The dispenser of claim 22, wherein the driving mechanism comprises:
a controller configured to control an operation of the driving mechanism; and
a storage device configured to store an instruction which, when executed by the controller, causes the controller to perform an operation including:
specifying a chip to be adhered to the circuit board;
obtaining chip position information of the chip;
obtaining nozzle position information indicating a current position of the dispenser nozzle;
moving the dispenser nozzle according to the chip position information and the nozzle position information;
obtaining supporting section position information indicating a current position of the supporting section;
moving the supporting section according to the chip position information and the supporting section position information; and
dispensing the adhesive substance onto the circuit board according to the chip position information.

32. The dispenser of claim 31, wherein the storage device is configured to store the instruction which, when executed by the controller, causes the controller to perform an operation including:
obtaining chip direction information of the chip;
obtaining nozzle direction information indicating a current direction of the nozzle tip with respect to the first and second directions;
determining whether the nozzle direction information corresponds to the chip direction information; and
rotating the nozzle tip to one of the first and second directions, according to a determination result.

33. The dispenser of claim 32, wherein the storage device is configured to store the instruction which, when executed by the controller, causes the controller to perform an operation including:
detecting a distance between the nozzle tip and a surface of the circuit board; and
controlling the position of the dispenser nozzle in the third direction according to the detected distance.

34. The dispenser of claim 22, further comprising:
a base configured to integrally support the supporting section, the dispenser nozzle, and the driving mechanism.

35. The dispenser of claim 34, wherein the dispenser nozzle comprises a connector configured to connect the dispenser nozzle to the base.

36. The dispenser of claim 35, wherein the connector comprises a first section at a predetermined position, and the base comprises a second section corresponding to the first section at a position corresponding to the predetermined position.

37. The dispenser of claim 36, wherein the first section and the second section are configured to connect with one another when the dispenser nozzle is connected to the base.

38. The dispenser of claim 37, wherein the first section comprises a concave section and the second section comprises a convex section.

39. The dispenser of claim 38, wherein the first section comprises a first mark and the second section comprises a second mark.

40. A dispenser nozzle, comprising:
a nozzle body configured to retain a viscous substance; and
means for dispensing at least one droplet of the viscous substance, having a shape extending toward a first direction, onto a predetermined point on a planar surface.

41. The dispenser nozzle of claim 40, wherein the dispensing means comprises:
means for dispensing the droplet in a second direction; and
means for limiting an amount of the droplet that is dispensed in a second direction perpendicular to the first direction.

42. A dispensing method, comprising the step of:
dispensing at least one droplet of a viscous substance, having a shape extending toward a first direction, onto a predetermined point on a planar surface.

43. A circuit board fabricating method, comprising the steps of:
dispensing at least one droplet of an adhesive substance, having a shape extending toward a first direction, onto a predetermined point on a circuit board;
placing a chip onto the predetermined point to cover the droplet; and
soldering the chip onto the predetermined point.
